(19) United States
(12) Patent Application Publication
(10) Pub. No.: US 2019/0041859 A1
(43) Pub. Date: Feb. 7, 2019

(54) SENSOR FAILURE COMPENSATION SYSTEM FOR AN AUTOMATED VEHICLE

(71) Applicant: Aptiv Technologies Limited, St. Michael (BB)

(72) Inventors: Junsung Kim, Pittsburgh, PA (US); Jong Ho Lee, Pittsburgh, PA (US); Junqing Wei, Bridgeville, PA (US); Wenda Xu, Pittsburgh, PA (US)

(21) Appl. No.: 15/669,134

(22) Filed: Aug. 4, 2017

(51) Int. Cl. G05D 1/02

(52) U.S. Cl. CPC G05D 1/0212; G05D 1/0088; G05D 1/0238; G05D 1/0257

(57) ABSTRACT

A sensor failure compensation system for an automated vehicle includes a forward sensor, at least one side sensor, and a controller. The forward sensor is configured to monitor a forward scene and output a forward signal. The side sensor is configured to monitor a side scene and output a side signal associated with the side scene. The controller is configured to receive and process the forward signal to selectively establish a forward task in association with the forward scene, and receive and process the side signal to selectively establish a side task in association with the side scene. The controller selects the side task if the forward sensor is not functional, or selects the forward task if the side sensor is not functional.

### BACKGROUND OF THE INVENTION

The present disclosure relates to an automated vehicle, and more particularly, to a sensor failure compensation system of the automated vehicle.

The operation of modern vehicles is becoming increasingly autonomous, causing a decrease in driver intervention. The various control features are becoming increasingly complex while vehicle accuracy, efficiency, and reliability must be at least maintained. The complex nature of such automated systems may require a large number of sensors. Such sensors may, at times, malfunction causing the vehicle to cease all operations, or substantially degrade vehicle performance and/or vehicle performance options.

### SUMMARY OF THE INVENTION

In one, non-limiting, exemplary embodiment of the present disclosure, a sensor failure compensation system for an automated vehicle includes a forward sensor, at least one side sensor, and a controller. The forward sensor is configured to monitor at least a forward scene and output a forward signal associated with the forward scene. The at least one side sensor is configured to monitor at least one side scene and output at least one side signal associated with the at least one side scene. The controller is configured to receive and process the forward signal to selectively establish a forward task in association with the forward scene, and receive and process the at least one side signal to selectively establish at least one side task in association with the at least one side scene. The controller is further configured to select the at least one side task if the forward sensor is not functional, or select the forward task if the at least one side sensor is not functional.

In another, non-limiting, embodiment, an automated vehicle includes at least one vehicle control, and a sensor failure compensation system. The vehicle control is adapted to produce a plurality of vehicle reactions. The sensor failure compensation system includes a first sensor, a second sensor, and a controller. The first sensor is configured to monitor a first scene and output a first signal associated with the first scene. The second sensor is configured to monitor a second scene and output a second signal associated with the second scene. The controller is configured to receive and process the first signal to establish a first potential task relative to the first scene and toward reaching a goal, and receive and process the second signal to establish a second potential task relative to the second scene and toward reaching the goal. The controller chooses one of the first and second potential tasks if the first or second sensor associated with the other of the first and second potential tasks is determined to be compromised, and outputs a command signal to the at least one vehicle control to effect the goal by performing the chosen one of the first and second potential tasks.

In another, non-limiting, embodiment, a computer software product is executed by a controller of an automated vehicle that includes first and second sensors configured to output respective first and second signals associated with respective first and second scenes. The computer software product includes a first sensor module, a second sensor module, and a compensation module. The first sensor module is configured to receive and process the first signal toward performing a first potential task, and make a determination on whether the first sensor is compromised. The second sensor module is configured to receive and process the second signal toward performing a second potential task, and make a determination on whether the second sensor is compromised. The compensation module is configured to receive the first potential task if the first sensor module determines that the first sensor is not compromised, receive the second potential task if the second sensor module determines that the second sensor is not compromised, and output a command signal to effectuate the first potential task if the second sensor is determined to be compromised by the second sensor module.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a top view of a host vehicle on a roadway and depicted with a sensor failure compensation system; and

FIG. 2 is a schematic of the host vehicle with the sensor failure compensation system.

### DETAILED DESCRIPTION

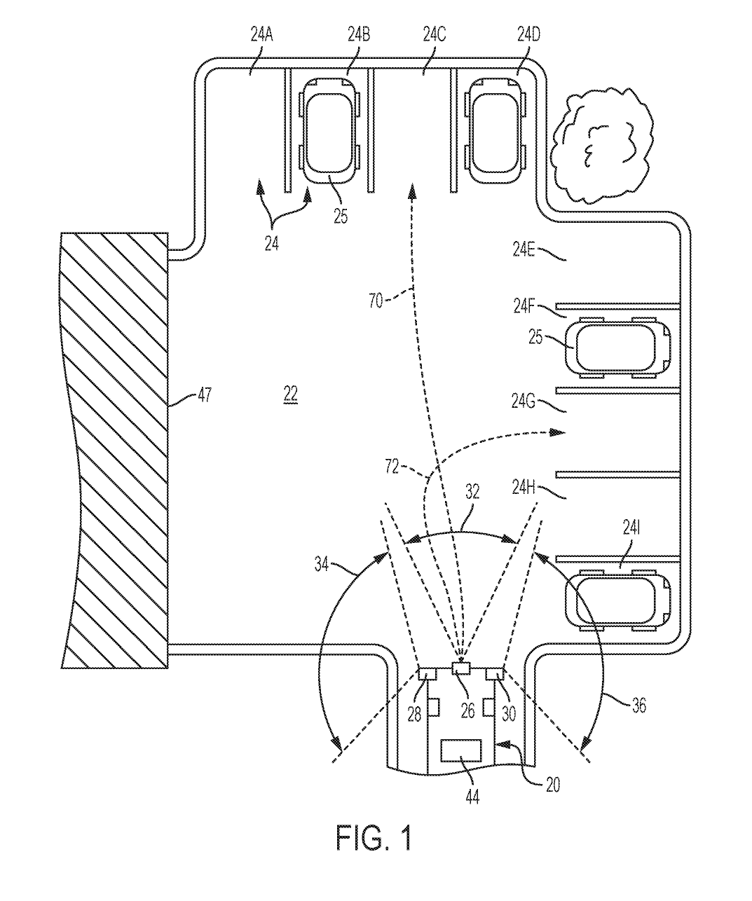

FIG. 1 illustrates a non-limiting example of a semi-autonomous or autonomous vehicle 20 (hereafter termed automated or host vehicle) that may include various systems and components that contribute toward partial or fully automated operation of the host vehicle 20. The various components and/or systems may control the speed, direction (e.g., steering), brakes and other aspects of the vehicle operation necessary for the host vehicle 20 to, for example, generally travel along, for example, a roadway. Such vehicle travel may be without the interaction of an occupant (not shown) within the host vehicle 20.

As one, non-limiting, embodiment, the host vehicle 20 is illustrated as entering a parking lot 22 with numerous parking spaces 24 that may be occupied or unoccupied by other parked vehicles 25. For example, parking spaces 24A-D are generally located forward of the host vehicle 20, with parking spaces 24A, 24C being unoccupied and parking spaces 24B, 24D being occupied. Similarly, parking spaces 24E-I are generally located to the right of the host vehicle 20, with parking spaces 24E, 24G, 24H being unoccupied and parking spaces 24F, 24I being occupied.

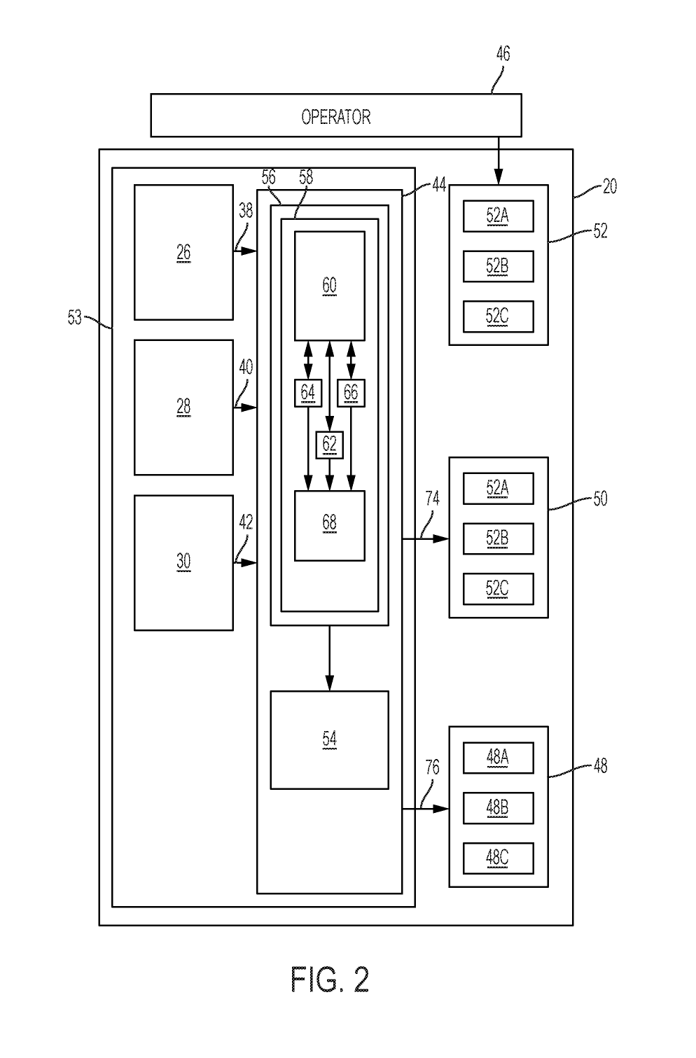

Referring to FIGS. 1 and 2, the host vehicle 20 may include a front or forward sensor 26, a left side sensor 28, and a right side sensor 30. The sensors 26, 28, 30 are configured to monitor respective forward, left, and right scenes (see arrows 32, 34, 36) that may slightly overlap one-another. A controller 44 of the host vehicle 20 is configured to receive forward, left, and right signals (see arrows 38, 40, 42) outputted from the respective forward, left, and right sensors 26, 28, 30. The forward sensor 26 may be mounted at the front and toward the middle of the host vehicle 20. The left and right sensors 28, 30 may be mounted to the respective sides, and or proximate to the front corners of the host vehicle 20. The sensors 26, 28, 30 may be of the same type or technology, or may differ in technology depending upon specific functions and tasks required of the sensor. The sensors 26, 28, 30 may be radar sensors, imaging devices (e.g., camera), LiDAR devices, or other sensors or combinations of sensors capable of monitoring regions of space (i.e., the scene). It is contemplated and understood that the sensors 26, 28, 30 may have different monitoring ranges. For example, the forward sensor 26 may be capable of detected objects at a distance that is about twice that of the side sensors 28, 30. The signals 38, 40, 42 may be sent over wired or wireless pathways (not shown).

As previously stated, the host vehicle 20 may be semi-autonomous or fully autonomous. In the example of a semi-autonomous host vehicle 20, the host vehicle may be typically driven by an operator 46 (see FIG. 2). In this case, an automation system (not shown) may provide assistance to the operator 46. This assistance may include the activation of a warning unit 48 (see FIG. 2), and/or may include activating a control override unit 50 that temporarily takes over the control of manual controls 52 of the host vehicle 20 that are typically used by the operator 46. Such manual controls 52 may include a directional unit 52A (e.g., steering unit), an acceleration unit 52B, and a braking unit 52C of the host vehicle 20. The warning unit 48 may include, or may be, an audible device 48A, a visual device 48B, and/or a haptic device 48C. In the example of a fully autonomous, host, vehicle 20, the automation system may simply command the controls 52 continuously, without significant operator intervention.

The host vehicle 20 includes a sensor failure compensation system 53. The sensor failure compensation system 53 may generally include the forward, left, and right sensors 26, 28, 30 and the controller 44. The system 53 functions to, at least partially, compensate for failure of one of the sensors 26, 28, 30 thereby relying on the remaining operative sensor(s). The controller 44 may include a processor 54 and an electronic storage medium 56. The processor 54 may be a microprocessor or other control circuitry such as analog and/or digital control circuitry including an application specific integrated circuit (ASIC) for processing data as is known by one with skill in the art. The storage medium 56 of the controller 44 may be non-volatile memory, such as electrically erasable programmable read-only memory (EEPROM) for storing one or more routines, thresholds, and captured data, hereafter referred to as an application 58 (e.g., a computer software product). The application 58 may be executed by the processor 54 of the controller 44 to recognize when one of the sensors 26, 28, 30 is compromised, and compensate for the compromised sensor by utilizing attributes of at least one other sensor and effecting an alternative reaction by the host vehicle 20.

The application 58 of the sensor failure compensation system 53 may include a database or electronic information file 60, a forward sensor module 62, a left side sensor module 64, a right side sensor module 66, and a compensation module 68. The database 60 and modules 62, 64, 66, 68 may generally be stored in the electronic storage medium 56, and the modules 62, 64, 66, 68 may be executed by the processor 54 of the controller 44. The database 60 may include preprogrammed information relative to travel routes, maps, geography, topology, object recognition data, and/or any other data that may assist the host vehicle 20, and/or sensor failure compensation system 53, in achieving a goal and/or destination.

Because the sensors 26, 28, 30 may not be redundant sensors configured to perform the same task (i.e., each sensor monitors a different scene), the sensor failure compensation system 53 functions to achieve a near equivalent, or equivalent goal (e.g., destination). For example, during normal operation when all of the sensors 26, 28, 30 are functioning properly, the goal of the host vehicle may be to park the vehicle in the parking lot 22. The same goal, but more refined, may be to park the host vehicle 20 in available parking space 24C (see arrow 70 in FIG. 1) possibly because: it requires minimal maneuvering of the vehicle, it is the largest of available parking spaces, and/or it is the closest space to a building 47. However, to achieve this refined goal, the forward sensor 26 may need to be functional.

In one embodiment, the forward sensor module 62 may assist in recognizing a plurality of potential tasks associated with the forward scene 32. The potential forward tasks may be to park the host vehicle in any one of the respective parking spaces 24A-D. The forward tasks associated with parking spaces 24B and 24D are omitted by module 62 because the module 62 may determine that the parking spaces are occupied. The module 62 may then utilize preprogrammed vehicle directives, or an operator command to choose between parking spaces 24A, 24C. The same principles may apply with the right sensor module 66 when choosing between a plurality of right tasks associated with respective parking spaces 24E-24I. When done, the controller 44 may again apply preprogrammed directives to choose between the selected forward parking space (e.g., space 24C) and the selected right parking space (e.g., space 24G). In an example where the forward sensor is inoperative, the option to park in space 24C is effectively removed.

In furtherance of the parking lot 22 example above, but in a scenario where the forward sensor 26 is determined to be compromised or not functional, the sensor failure compensation system 53 is able to achieve parking the host vehicle 20 in the parking lot 22 (i.e., the goal), but also functions to compensate, or redirect (see arrow 72 in FIG. 1), the vehicle into an alternate parking space 24G utilizing the right side sensor 30. Therefore, the compensation system 53 achieves the general goal (i.e., parking in lot 22), but compensates upon failure of forward sensor 26 by not parking in space 24C and instead parking in space 24G. It is further contemplated and understood that the sensor failure compensation system 53 may also be applied to any other variety of other scenarios and sensor configurations. For example, the host vehicle may only have two sensors (not three) located on the forward left and right corners of the vehicle, and the scenario may be to navigate through an intersection.

In operation of the sensor failure compensation system 53, and utilizing the parking lot scenario, the forward sensor 26 may be compromised, and as such, may not send a forward signal 38 (or may send a compromised forward signal 38) to the forward sensor module 62 of the application 58. The forward sensor module 62 may be configured to thereby determine that the forward sensor 26 is compromised and may notify the compensation module 68 accordingly. The left and right sensor modules 64, 66 receive the respective left and right signals 40, 42 and process the signals to monitor the corresponding scenes 34, 36. Each module 64, 66 may utilize preprogrammed information from the database 60 to assist in monitoring and various recognitions associated with the respective scenes 34, 36. The modules 64, 66 may then communicate the processed signals to the compensation module 68.

The compensation module 68 may process the data from the modules 62, 64, 66, correlate the data with a directed goal from, for example, the operator 46, and choose a specific task by outputting a command signal (see arrow 74) to the control override unit 50. The compensation module 68 may also send a command signal 76 to the warning unit 48 to notify the driver 46 (or technician) of the inoperative forward sensor 26.

In general, the preprogrammed directive of the controller 44 may be to minimize turning or maneuvers within a parking lot when choosing a parking space, or may be to choose the largest parking space closest to a door of a building 47. The compensation module 68 may generally function to at least partially override this directive, or at least recognize when the available options are minimized because the host vehicle 20 may be at least partially “blind” in, for example, a forward direction. More specifically, and at the moment the host vehicle 20 enters the parking lot 22, the application 58 may not recognize any available parking spaces 24 in the forward direction, but does process/recognize the parking spaces 24 toward the right via the operative right sensor 30.

Accordingly, a sensor failure compensation system 53 for automated operation of the host vehicle 20 advances the automated vehicle arts by enabling a system, application, or controller to perform self-diagnostics and compensating action, thereby improving overall vehicle performance and reliability.

The various functions described above may be implemented or supported by a computer program that is formed from computer readable program codes, and that is embodied in a computer readable medium. Computer readable program codes may include source codes, object codes, executable codes, and others. Computer readable mediums may be any type of media capable of being accessed by a computer, and may include Read Only Memory (ROM), Random Access Memory (RAM), a hard disk drive, a compact disc (CD), a digital video disc (DVD), or other forms.

Terms used herein such as component, application, module, system, and the like are intended to refer to a computer-related entity, either hardware, a combination of hardware and software, or software execution. By way of example, an application may be, but is not limited to, a process running on a processor, a processor, an object, an executable, a thread of execution, a program, and/or a computer. It is understood that an application running on a server and the server, may be a component. One or more applications may reside within a process and/or thread of execution and an application may be localized on one computer and/or distributed between two or more computers

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. A sensor failure compensation system for an automated vehicle, the sensor failure compensation system comprising:
a forward sensor configured to monitor at least a forward scene and output a forward signal associated with the forward scene;
at least one side sensor configured to monitor at least, at least one, side scene and output at least one side signal associated with the at least one side scene; and
a controller configured to receive and process the forward signal to selectively establish a forward task in association with the forward scene, and receive and process the at least one side signal to selectively establish at least one side task in association with the at least one side scene, wherein the controller is configured to select the at least one side task if the forward sensor is not functional or select the forward task if the at least one side sensor is not functional.

2. The sensor failure compensation system set forth in claim 1, wherein the at least one side sensor includes a left side sensor and a right side sensor.

3. The sensor failure compensation system set forth in claim 1, wherein the forward sensor and the at least one side sensor are imaging devices.

4. The sensor failure compensation system set forth in claim 1, wherein the forward sensor and the at least one side sensor are LiDAR sensors.

5. The sensor failure compensation system set forth in claim 1, wherein the forward sensor and the at least one side sensor are radar sensors.

6. The sensor failure compensation system set forth in claim 1, wherein the at least one side sensor includes a right side sensor and the side task is directing the automated vehicle in a substantially right direction.

7. The sensor failure compensation system set forth in claim 6, wherein the forward task is directing the automated vehicle in a substantially forward direction.

8. The sensor failure compensation system set forth in claim 7, wherein the side task is directing the automated vehicle in the right direction and into a first parking space within the side scene, and the forward task is directing the automated vehicle in the forward direction and into a second parking space within the forward scene.

9. The sensor failure compensation system set forth in claim 1, wherein the controller includes a processor and an electronic storage medium.

10. An automated vehicle comprising:
at least one vehicle control adapted to produce a plurality of vehicle reactions; and
a sensor failure compensation system including;
a first sensor configured to monitor a first scene and output a first signal associated with the first scene,
a second sensor configured to monitor a second scene and output a second signal associated with the second scene,
a controller configured to receive and process the first signal to establish a first potential task relative to the first scene and toward reaching a goal, receive and process the second signal to establish a second potential task relative to the second scene and toward reaching the goal, choose one of the first and second potential tasks if the first or second sensor associated with the other of the first and second potential tasks is determined to be compromised, and output a command signal to the at least one vehicle control to effect the goal by performing the chosen one of the first and second potential tasks.

11. The automated vehicle set forth in claim 10, wherein the controller includes a processor and an electronic storage medium.

12. The automated vehicle set forth in claim 11, wherein the sensor failure compensation system includes first and second sensor modules executed by the processor, stored in the electronic storage medium, and configured to receive and process the respective first and second signals to determine the first and second potential tasks.

13. The automated vehicle set forth in claim 12, wherein the sensor failure compensation system includes a compensation module executed by the processor, stored in the electronic storage medium, and configured to choose one of the first and second potential tasks if the first or second sensor associated with the other of the first and second potential tasks is determined to be compromised.

14. The automated vehicle set forth in claim 10, further comprising:
a warning unit configured to receive a second command signal from the controller if one of the first and second sensors is determined to be compromised.

15. A computer software product executed by a controller of an automated vehicle including first and second sensors configured to output respective first and second signals associated with respective first and second scenes, the computer software product comprising:
a first sensor module configured to receive and process the first signal toward performing a first potential task, and make a determination on whether the first sensor is compromised;
a second sensor module configured to receive and process the second signal toward performing a second potential task, and make a determination on whether the second sensor is compromised; and
a compensation module configured to receive the first potential task if the first sensor module determines that the first sensor is not compromised, receive the second potential task if the second sensor module determines that the second sensor is not compromised, and output a command signal to effectuate the first potential task if the second sensor is determined to be compromised by the second sensor module.

16. The computer software product set forth in claim 15, further comprising a database including preprogrammed instructions providing directives to assist the first sensor module, the second sensor module, and the compensation module in recognizing and choosing a plurality of potential tasks.

17. The computer software product set forth in claim 16, wherein the first and second potential tasks are associated with choosing a parking space.

18. The computer software product set forth in claim 16, wherein the second potential task is dependent upon the first sensor being compromised.

19. The computer software product set forth in claim 18, wherein the first sensor is a forward sensor, and the second potential task is deceleration.
